(19) United States
(12) Patent Application Publication
(10) Pub. No.: US 2017/0091725 A1
(43) Pub. Date: Mar. 30, 2017

(54) AUCTION AND PAYMENT PROCESSING METHODS FOR POINTS OF CHARITY FUND RAISERS

(71) Applicant: David John Pesch, La Palma, CA (US)

(72) Inventor: David John Pesch, La Palma, CA (US)

(21) Appl. No.: 15/018,648

(22) Filed: Feb. 8, 2016

Related U.S. Application Data
(60) Provisional application No. 62/232,738, filed on Sep. 25, 2015.

(51) Int. Cl. G06Q 20/10; G06Q 30/02; G06Q 30/08

(52) U.S. Cl. CPC G06Q 20/102; G06Q 30/08; G06Q 30/0279

(57) ABSTRACT

The present invention teaches a method of conducting an auction on behalf of a charity or other organization, including having bidders provide payment information at a check-in, and giving to each bidder a sticker sheet having thereon a machine scan able code associated with the bidder. Bid sheets for each auction item have a space to affix a sticker associated with a code which combines both an item identifier and a bid price identifier. The invention further teaches that each auction event may have a payment processing gateway account set up, and the amounts receivable from winning bidders after the conclusion of bidding may be batch processed using the gateway. Numerous convenience features are designed to make carrying out the auction extremely convenient, including locating bidders by table, providing instant SMS messaging templates for communication, allowing purchases and donations in addition to bids and more.

### FIELD OF INVENTION

This invention relates generally to auction methods and specifically to improved payment resolution methods for charity auctions.

### STATEMENT REGARDING FEDERALLY FUNDED RESEARCH

This invention was not made under contract with an agency of the US Government, nor by any agency of the US Government.

### BACKGROUND OF THE INVENTION

Modern auction techniques have advanced considerably from the traditional picture of a podium, an auctioneer and some paddles. While the auction houses and bankruptcy sales still exist, a thriving branch of the auction business is the sponsored event in which an organization (for example, a charity, a group, etc) will obtain help in putting on an auction for a good cause: to pay for a group activity, to receive charitable donations, to fund specific needs and so on.

In some instances an auction organizing group may be asked to handle the actual mechanics of holding the auction. This has evolved considerably from the days when an auctioneer showed up with a gavel and nothing more need be done.

In the more modern milieu, most potential bidders will not carry a check book or large amounts of cash (although some will) and so arrangements have to be made to accept electronic means of payment. Similarly, the auction staff will not know most attendees so a careful registration must be carried out. Bidding may not be a “live” auction but may be a silent auction, an opportunity or the like. After the auction, an enormous amount of payment processing must occur.

And if the auction is a charity event for a good cause, the bidders need to be kept unaware or only minimally aware that these mechanics are happening around them. Thus, speed of handling an auction's set-up, administration, and aftermath are vital.

One known attempt to provide a faster method of handling a silent auction is taught by U.S. Pat. No. 5,803,500 entitled “Method and Kit for Conducting an Auction” and issued to Mossberg Sep. 8, 1998. This item teaches a triple scan of bar codes: a first barcode is used to identify each item for auction, a second barcode is used to identify a price, a third barcode is used to identify a bidder. In practice, the silent auction bidder receives a sheet of adhesive labels with that bidder's identifying barcode on each and places them next to a selected price.

It may be seen that this speeds up, to a degree, one aspect of the auction performance. In particular, the auction staff may perform THREE scans to determine the winner of a silent auction. Scanning the item barcode, locating the highest bid and scanning that and the bidder barcode on the adhesive label thereby allows semi-automated entry of the winner and the amount of the winning bid. This high speed scanning of sales information minimizes the time required for recording and processing of sales data. Importantly, it reduces human transcription errors to almost zero (col. 5, line 35).

In addition, U.S. Pat. No. 5,803,500 teaches some very basic “data processing” reporting.

However, while this somewhat speeds the silent auction process, this item of prior art is by no means an integrated system which has been thought through to serve the needs of the sponsoring organization and the auction staff from beginning to end. It does not significantly aid with the payment process (although payment information may be pre-entered), with the handling of rejected payments, nor does it provide speedy access to information and data modules for auction staffers, and so on.

It would be preferable to provide a specialized auction handling organization, scan structure and data management system which speeds almost every facet of the auction experience for the convenience of the bidders and host organization.

It would further be preferable to provide an improved method which reduces the amount of scanning required.

It would yet further be preferable to provide methods to generate real-time empirical data as the auction happens.

It would yet further be preferable to provide methods for almost instantaneous settlement by electronic means, non-sequentially, for all amounts receivable at the end of the auction/event.

It would yet further be preferable to provide methods for handling, instantly and on the auction site, cases in which payments are divided between methods (such as a debit card plus check being used to cover a payment).

### SUMMARY OF THE INVENTION

The present invention teaches a method and device for carrying out an auction with greatly reduced workloads, increased speed, and greater accuracy.

In one embodiment, only two codes are required for scanning at the completion of an auction. Prior to the auction, each bidder gets a unique machine readable code of their own (such as a number like 500 or 740). Each unique bidder code is associated in a Patron Profile with the bidder by name, other data, etc. In addition, each item gets a set of unique numbers, each one of the unique numbers representing not only the item itself but also one possible bid price for the item. This pairing produces a unique item-price code combination. Note that in addition to the machine readable code, a human readable code may be used. The human readable code may be anonymized (that is, a bare “500”, with no name or other identifying characteristic) or may in alternative (and less preferred embodiments) be something such as a name: “John Smith”. After the auction, high speed scanning equipment allows fast determination of the winner's identity for each item as well as their winning bid.

Note that compared to prior systems such as the '500 patent, only two codes need be scanned per item rather than three. By this means, the overhead in terms of scanning is reduced by ⅓. This in turn means a ⅓ reduction in errors due to staffers scanning the wrong codes and so on.

In addition, quick and easy registration and sign-in modules are provided which gather the credit card data or other payment data of bidders (who may be individuals or groups), along with other information. Thus before conducting the auction, the patrons' information is compiled. It may be saved from a database of previous patrons and simply downloaded for the auction, or selectively downloaded, or it may be compiled for the specific fund raising event, or at the admission door. Each patron receives a Profile, the unique bidder code, (a bar code, QR code, etc). Note that the bidder code may of course include additional encoded information such as previous sponsorship or affiliation of the patron, preferences, auction date, place, sponsor, type of event, and so on and so forth.

Uniquely, the present invention teaches that a payment gateway account may be set up on behalf of an individual charitable/sponsor organization and even set up for a single auction/event. Prior to the auction, bidder information may be collected from the bidders and stored in a security compliant server for use after the auction. By this means, a drastic efficiency increase may be created in payments. In particular, the present invention teaches that in addition to the option to process a payment individually, the device of the invention may use the gateway to BATCH process all payments outstanding with as few as two clicks/keystrokes. The results of these payments settlement through the banking/credit card system may thus be known almost instantly, in fact, while the event is still ongoing.

This advantage may in turn be leveraged to provide additional unique features, in particular, payments which failed, were rejected, turned out to have erroneous payment information and so on will be known immediately, while the event is still happening. The bidder information collected at the start of the event may include a mobile telephone number, a text address or other electronic communication address, and especially, a physical location within the auction venue. This last item may be assigned seating (seat 7, row B, section 2) or may be a table number (often used at more formal events, dinner events and the like). By either means, bidders whose payments failed may be contacted instantly, for example by means of a template SMS text message, or by having a staffer check the table and very quietly inform the bidder of the problem, etc.

In addition, it will be seen by means of various vastly simplified screenshots that the device of the invention is designed with human factors in mind, in particular, the layout of the program GUI allows virtually instant access to any required function, minimizes or even eliminates scrolling and so on.

These and many other aspects, advantages, embodiments and objectives of the present invention will be understood by reference to the following.

### SUMMARY IN REFERENCE TO THE CLAIMS

It is therefore one aspect, advantage, objective and embodiment of the present invention, in addition to those described above, to provide a method of conducting on behalf of a client organization an auction of a plurality of items and also with a number of bidders, each bidder having at least one electronic payment method, the method comprising the steps of:

prior to the auction setting up a payment processing gateway account operable to capture and store payment information for such electronic payment methods and further operable to process payments made using the payment information;

prior to the auction obtaining from each such bidder, such bidder's payment information for such bidder's electronic payment method, associating such bidder's payment information with such bidder, and storing the payment information in a first database accessible to the payment processing gateway account;

allowing bidding by such bidders on such items;

after bidding has ended, determining a winning bid for each item and associating such winning bid with a winning bidder selected from among such bidders;

after determining winning bids, batch processing payments of the winning bidder of all such items using the stored payment information for such electronic payment methods associated with each winning bidder.

It is therefore one aspect, advantage, objective and embodiment of the present invention, in addition to those described above, to provide a method of conducting an auction further comprising:

providing a service provider organization able to service multiple such client organizations, the service provider organization having the ability to set up at least one unique payment processing gateway on behalf of each such client organization.

It is therefore one aspect, advantage, objective and embodiment of the present invention, in addition to those described above, to provide a method of conducting an auction further comprising:

providing a service provider organization able to service multiple such client organizations, the service provider organization having the ability to access at least one unique payment processing gateway belonging to such client organization.

It is therefore one aspect, advantage, objective and embodiment of the present invention, in addition to those described above, to provide a method of conducting an auction wherein such client organizations may be one member selected from the group consisting of: charity organizations, professional auctioneers, auction houses, receivers, governmental organizations, private businesses and combinations thereof.

It is therefore one aspect, advantage, objective and embodiment of the present invention, in addition to those described above, to provide a method of conducting an auction further comprising:

prior to the auction associating with each such bidder at least one piece of contact/location information of each such bidder, the contact/location information selected from the group consisting of: mobile telephone number, mobile device contact information, email address, other electronic address, seat number, table number, room number, and combinations thereof.

It is therefore one aspect, advantage, objective and embodiment of the present invention, in addition to those described above, to provide a method of conducting an auction further comprising:

after batch processing of payments, using such bidder's contact/location information to contact such bidder in any event selected from the list consisting of: the payment being rejected, such payment information being rejected, the payment being accepted, and combinations thereof.

It is therefore one aspect, advantage, objective and embodiment of the present invention, in addition to those described above, to provide a method of conducting an auction further comprising the steps of:

providing an industry compliant gateway server having a process and having a non-volatile memory and having in such non-volatile memory instructions for carrying out at least one of the steps of the invention;

performing using the industry compliant gateway server the one step of the invention per the instructions.

It is therefore one aspect, advantage, objective and embodiment of the present invention, in addition to those described above, to provide a method of conducting an auction wherein the step of setting up at least one unique payment processing gateway on behalf of each such client organization further comprises:

setting up at least one unique payment processing gateway for each individual auction of such client organization.

It is therefore one aspect, advantage, objective and embodiment of the present invention, in addition to those described above, to provide a method of conducting an auction wherein the electronic payment method is a credit/debit card, and further wherein the payment information is one member selected from the group consisting of: card number, card holder name, CVV code, card holder address, PIN number, and combinations thereof.

It is therefore one aspect, advantage, objective and embodiment of the present invention, in addition to those described above, to provide a method of conducting an auction further comprising the step of:

initiating a test transaction using the stored payment information, and

if the test transaction fails, using such bidder's contact/location information to contact such bidder.

It is therefore one aspect, advantage, objective and embodiment of the present invention, in addition to those described above, to provide a method of conducting an auction further comprising the step of:

if the test transaction occurs, voiding the test transaction.

It is therefore one aspect, advantage, objective and embodiment of the present invention, in addition to those described above, to provide a method of conducting an auction further comprising the step of:

offering to such bidders the option to make a donation to such client organization,

if one such bidder makes a donation, using the stored payment information to process the donation.

It is therefore one aspect, advantage, objective and embodiment of the present invention, in addition to those described above, to provide a method of conducting an auction further comprising the steps of:

prior to the auction assigning to each such bidder a unique bidder code, which bidder code is machine readable, and storing such unique bidder code associated with such bidder payment information;

providing to each such bidder a bid sticker sheet having thereon at least one sticker printed with such bidder's unique bidder code, the at least one sticker having a size and shape;

prior to the auction creating a bid sheet having thereon a plurality of item-price codes, each item-price code being readable both by machine and by such bidders, each item-price code identifying one such item being bid upon and a price bid for that item, the plurality of item-price codes on the bid sheet each being for the same item but for different prices for such item, the prices spanning a desired range of bidding;

the bid sheet having associated with every item-price code at least one bid space matching the stickers' size and shape;

during bidding allowing such bidders to remove from their bid sticker sheet the at least one sticker having thereon such bidder's unique code, and allowing such bidder to place the at least one sticker upon the bid sheet in the bid space;

whereby the bidder silently and potentially anonymously bids upon such item;

at the conclusion of bidding, gathering such bid sheets and scanning in the unique bidder code found upon the sticker in the bid space associated with the highest item-price which was bid for such item, whereby a winning bid and a winning bidder for each such item is determined;

processing payment information associated with such bidder, for the amount of the item-price bid.

It is therefore one aspect, advantage, objective and embodiment of the present invention, in addition to those described above, to provide a method of conducting an auction wherein:

if one such bidder has become the winning bidder for more than one such item, totaling the amount of such bidder's winning bids prior to processing that bidder's payment information;

whereby in the event that such bidder's payment fails, the bidder may be contacted for potential partial payment.

It is therefore one aspect, advantage, objective and embodiment of the present invention, in addition to those described above, to provide a method of conducting an auction further comprising the steps of:

at the conclusion of bidding, gathering such bid sheets and scanning in the unique bidder code found upon the sticker in the bid space associated with the second highest item-price which was bid for such item, whereby a substitute winning bid and a substitute winning bidder for each such item is determined;

in the event that processing the winning bidder's payment information fails, processing payment information associated with such substitute bidder, for the amount of the substitute item-price bid.

It is therefore one aspect, advantage, objective and embodiment of the present invention, in addition to those described above, to provide a method of conducting an auction for use with a bidder having a second payment method, the method further comprising the steps of:

obtaining from such bidder, such bidder's second payment information for such bidder's second electronic payment method, associating such bidder's second payment information with such bidder, and storing the second payment information in the database accessible to the payment processing gateway account;

prior to processing payments, offering to such bidder the option to divide payment among payment methods selected from the group consisting of: such second payment information, such first payment information, a cash payment, a check payment, and combinations thereof.

It is therefore one aspect, advantage, objective and embodiment of the present invention, in addition to those described above, to provide a method of conducting an auction wherein the step of batch processing payments further comprises the steps of:

activating with a first command a selection module which selects all of the winning bidders at once;

activating with a second command a submission module which submits all payments at once via the payment processing gateway account.

It is therefore one aspect, advantage, objective and embodiment of the present invention, in addition to those described above, to provide a method of conducting an auction wherein the step of batch processing payments further comprises:

the submission module activating a receipt module operative to create a receipt for each payment which is successfully processed,

the submission module leaving payments which failed to process showing in a payments receivable module.

It is therefore one aspect, advantage, objective and embodiment of the present invention, in addition to those described above, to provide a method of conducting an auction further comprising:

the submission module generating a report showing a status for each payment, the status for each payment including an indication that the payment was successful or in the alternative indicating that the payment failed and a reason for failure.

It is therefore one aspect, advantage, objective and embodiment of the present invention, in addition to those described above, to provide a method of conducting an auction further comprising:

an SMS text messaging module operative to generate and send to each such bidder, after bidding has ended, an SMS text message informing the bidder of all auctions they won, all auctions they lost, and related information;

the SMS text messaging module having a second database of template SMS text messages which have fields which may be auto populated by the SMS text messaging module, the fields including at least one member selected from the list consisting of: first name, last name, bidder number, item name, item number, table number, payment amount, winning bid amounts, and combinations thereof.

It is therefore one aspect, advantage, objective and embodiment of the present invention, in addition to those described above, to provide a method of conducting an auction further comprising:

providing a spreadsheet module allowing easy data entry into a spreadsheet of a list of silent auction items, live auction items, such bidder information, such bidder payment information, and combinations thereof;

providing an input module operative to receive the spreadsheet and save the contents of the spreadsheet, thereby populating the first database automatically;

the input module further operative to receive the spreadsheet and generate the bid sheets and the bid sticker sheets.

It is therefore one aspect, advantage, objective and embodiment of the present invention, in addition to those described above, to provide a method of conducting an auction further comprising:

providing a dynamic table assignment module allowing the batch uploading of table assignments, individual table assignments, and table reassignments.

It is therefore one aspect, advantage, objective and embodiment of the present invention, in addition to those described above, to provide a method of conducting an auction further comprising:

providing a check-in module displaying the number and identities of such bidders who have provided such payment information by checking-in.

It is therefore one aspect, advantage, objective and embodiment of the present invention, in addition to those described above, to provide a method of conducting an auction further comprising:

providing an item counter module operative to track the number of such items, the item counter module further operative to enforce a limit on the number of such items.

It is therefore one aspect, advantage, objective and embodiment of the present invention, in addition to those described above, to provide a method of conducting an auction further comprising:

a page size limitation, the page size limitation being a maximum limit to the vertical height of a single page display, the page size limitation being set to be no larger than the height of a first electronic display screen, the page size limitation being enforced for all pages displayed while carrying out the invention;

whereby at no time is it necessary to scroll while carrying out the invention.

It is therefore one aspect, advantage, objective and embodiment of the present invention, in addition to those described above, to provide a method of conducting an auction further comprising: a total revenue module operative to track and display revenues generated during the auction, the display of the revenues provided both as a grand total and also broken down by a plurality of sub-categories of the event, including auction amounts by type of auction, donation amounts, sales, by such bidders' names, by a table number, and by at least one other bidder characteristic.

It is therefore one aspect, advantage, objective and embodiment of the present invention, in addition to those described above, to provide a method of conducting an auction further comprising:

a suggested retail value for each such item, the suggested retail value being printed upon a receipt for convenient reference for tax purposes.

It is therefore one aspect, advantage, objective and embodiment of the present invention, in addition to those described above, to provide a method of conducting an auction on behalf of a client organization of a plurality of items and also with a number of bidders, the method comprising the steps of:

prior to the auction assigning to each such bidder a unique bidder code, which bidder code is machine readable, and storing such unique bidder code associated with such bidder;

providing to each such bidder a bid sticker sheet having thereon at least one sticker printed with such bidder's unique bidder code, the at least one sticker having a size and shape;

prior to the auction creating a bid sheet having thereon a plurality of item-price codes, each item-price code being readable both by machine and by such bidders, each item-price code identifying one such item being bid upon and a price bid for that item, the plurality of item-price codes on the bid sheet each being for the same item but for different prices for such item, the prices spanning a desired range of bidding;

the machine readable codes printed in a format selected from the group consisting of: UPC-A, UPC-E, EAN-8, EAN-13, QR codes, Aztec, Data Matrix ECC200, PFD417, Code 39, Code 93, Code 128, ITF, other machine readable codes now known or later devised, and combinations thereof;

the bid sheet having associated with every item-price code at least one bid space matching the stickers' size and shape;

during bidding allowing such bidders to remove from their bid sticker sheet the at least one sticker having thereon such bidder's unique code, and allowing such bidder to place the at least one sticker upon the bid sheet in the bid space;

whereby the bidder silently and potentially anonymously bids upon such item;

at the conclusion of bidding, gathering such bid sheets and scanning in the unique bidder code found upon the sticker in the bid space associated with the highest item-price which was bid for such item, whereby a winning bid and a winning bidder for each such item is determined.

### BRIEF DESCRIPTION OF THE DRAWINGS

FIG. 1 is a block diagram of a credit card processing system including a payment gateway, showing the system in that context.

FIG. 2 is a block diagram showing important modules of the system, certain hardware components, etc.

FIG. 3 is an exemplary sticker sheet according to the bid sticker sheet of the invention.

FIG. 4 is an exemplary bid sheet according to the invention.

FIG. 5 is a flow chart of the steps of the invention.

FIG. 6 is a flow chart of the steps of the invention according to an alternative embodiment.

FIG. 7 is a greatly simplified screenshot of a module which records bids, provides information on bidding and so on.

FIG. 8 is a greatly simplified screen shot depicting a module which allows two-click batch processing of all orders, whereby the invention allows much greater speed as well as additional structures which could not be provided without leveraging this ability.

FIG. 9 is a simplified screenshot of an item setup/data input module of the invention allowing auction staff to create an auction with great speed.

FIG. 10 is a simplified screen shot of an event set up screen allowing automatic creation of a silent auction (items in particular) from a spreadsheet, thus allowing a host/sponsor organization to easily interface with an auction event providing organization.

FIG. 11 is a simplified screen shot of an event set up screen allowing automatic entry of patrons/bidders of the auction, and showing that bidders may in fact be saved from event to event in the files of the auction event provider.

FIG. 12 is a simplified screen shot of a check-in module, showing the invention's ease of checking attendance, printing out stickers for a silent auction, paddles for a live auction and so on.

FIG. 13 is a simplified screen shot of a data input module for bidder registration, focusing in particular on entry of payment information for later use.

FIG. 14 is a screen shot of a module showing that patrons may be more than bidders: they may also make donations by funding a specific need which they can select.

FIG. 15 is a screen shot of an “opportunity” module of the invention allowing patrons to purchase items for sale at the auction.

### INDEX OF REFERENCE NUMERALS

Bidder 100
Bidder payment card 102
Bidder issuing bank 104
Auction(s) 106
Items 108
First charity organization 110
Second charity organization 112
Second charity gateway (pre-existing) 114
Service provider 116
Custom gateway 118
Credit card settlement network 120
Bidder bank 122
Charity bank 124
Compliant server 202
Non-volatile memory 204
Bidder Profile database 206
Bidder location information+dynamic table assignment module 208
Bidder payment information 210
Test transaction module 212
Donation module 214
Sales module 216
Data input module 218
Batch payment submission 220
Receipt module 222
SMS text module 224
Spreadsheet module 226
Check-in module 228
Item counter module 230
Revenue module 232
Set up custom gateway 502
Get bidder payment info & create Profile 504
Associate and store (compliant) 506
Bidding 508
Determine payments 510
Batch process payments 512
Offer service (provider) 602
Input items 604
Associate & store contact information of bidders 606
Test transactions 608
Assign bidder codes 610
Print & distribute bid sticker sheets 612
Print & distribute bid sheets 614
Auction per steps 502-512 616
Contact rejected payments 618
Page header 702
Tab system 704
Data input area/tables 706
Vertical height limit 710
Receipt printing 802
Batch processing (esp. payments) 804
Data display area/tables 806

### DETAILED DESCRIPTION

### Glossary

For purposes of the present invention, a bidder or patron is an entity or individual invited to an auction by the client/sponsoring/host organization. However, this individual/entity may be anything from a single person, to a person accompanied by non-bidding individuals, to a group of bidders, or a company, firm, body, or the like.

One important feature of the present invention is the creation of a Patron Profile, which Profile is stored in a security compliant manner. The patron profile may include several items such as the patron's (bidder's) names, the number of actual individuals attending an event with or as part of the patron, what events/needs/causes this individual has contributed to in the past, address, phone number and so on. Significantly, the Profile will/may also contain: payment information sufficient to process a payment from the patron without further input, contact information for the patron at the event venue itself, such as a table number, mobile phone number, messaging address, and so on, in addition to amounts owed and so on. The Profiles may be saved and used as the basis for further events/auctions, possibly even for events/auctions held by different charitable organizations than the one at which the profile was originally created. Importantly to the working of the invention, the Profile will have a “bidder number” associated with the patron as well.

Data will be saved per Payment Card Industry Data Security Standards, that is, credit card information will not be readily accessible. The entire system of the invention has numerous levels of access and responsibility, follows industry protocols for server operations and so on and so forth. The terms “industry compliant gateway server” or “security compliant” will be used herein to refer to this.

A payment gateway is a commerce application service provider that authorizes electronic payment methods (such as but not limited to credit cards, debit cards, cash cards and the like) for e-businesses, online retailers, brick and mortar stores having clicktopay operations, and so on. A payment gateway serves to create or facilitate data exchange between a payment portal/cart/mobile device/etc and the actual banking system per se. Commonly known examples of such payment gateways include Authorize.net™, Paypal®, Square® and so on.

A live auction is a traditional auction in which bidders compete in real-time, often in the same location, for an item being offered for auction and thus purchase. Paddles with numbers thereon may be employed to allow auction staff to recognize bids and locate high bidders after an item has closed.

A silent auction may be an auction carried out in an alternative format such as by placing stickers onto bid sheets.

An “Opportunity” as used herein is an item offered for sale. Thus, an event might offer glasses of wine, or bottles of wine, for consumption either during the event or later. However, consumables are not the only items offered, the item may be anything which could be auctioned or otherwise sold. Note that the lines may blur between types of auction events as an item with a “buy now” price could be considered either an opportunity or an auction item.

A donation to fund a specific need is also a potential source of a payment at an event. An event may offer more than one choice, as well, as a hosting organization may allow patrons to fund either a new major purchase (the renovation of a concert hall) or the general fund for operations of the organization or perhaps a specific event (the production of a specific operatic or theatrical piece), or different types of charitable giving (schools versus a homeless shelter).

The term “charity organization” or “client organization” is used frequently herein but it is to be understood that other organizations may be holding auction events within the scope of the invention: businesses, private individuals, museums, repossession organizations, banks, common carriers, governmental agencies and any other group or individual which may from time to time hold an auction but which may not have the infrastructure constantly in place to do so. These organizations may then become “clients” of the service provider organization, “hosts” of the event and “sponsors” of both the auction and potentially one or more good causes served by the auction.

A service provider for this invention is an organization which assists the “charity organizations” to hold the auction. The service provider may provide staff, provide easy to use spreadsheets to allow uploading—or even downloading—of patron lists, item lists and the like, may administer the auction, prepare the auction and so on.

“Items” as the term is used herein includes not just physical goods but also services, experiences, event tickets, opportunities, donations, and so on. SRV as used herein refers to “suggested retail value”, a term useful for patrons in calculating taxes.

### Glossary End

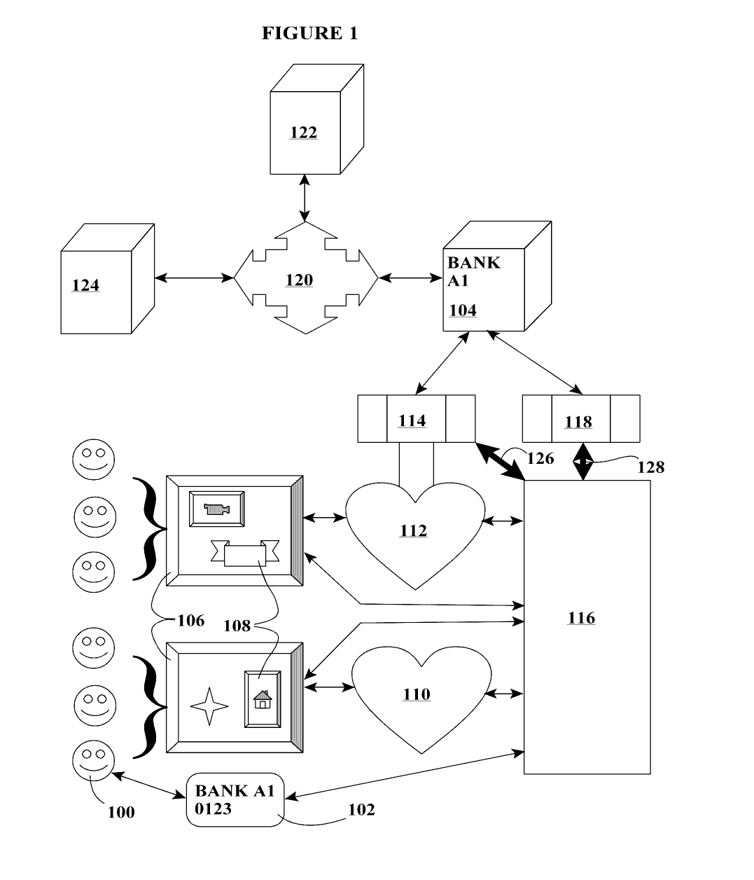

FIG. 1 is a block diagram of a credit card processing system including a payment gateway, showing the system in that context. Bidder 100 (depicted with a smiley-face icon) is only one of a number of bidders, however this bidder's situation may be taken to be exemplary.

Bidder payment card 102 may be a credit card, debit card or other form of electronic payment now known or later devised. Prior to the auction the bidder will provide sufficient payment information to allow processing of payments later.

Bidder issuing bank 104 may be the bank or other entity which issues the electronic payment method (the card). As an issuer it will have to be tied into the overall credit card settlement network 120.

Auction(s) 106 may be any number of charity events held by one or more organizations. Items 108 may be the items sold at the auctions, which may be unique or may be bulk products or anything in between.

First charity organization 110 and second charity organization 112 may know of one another or they may be entirely distinct, connected only and unwittingly by their individual relationships with the auction service provider 116.

Second charity 112 has a pre-existing gateway 114 for receiving payments from its patrons. However, it will be seen that first charity 110 does not. Both can be serviced by the provider 116: in the case of organization 110, a custom gateway 118 may be created and utilized on behalf of the charity 110 by the service organization. The service organization 116 will represent the gateway (organization) in setting up the new gateway 118 belonging to the charity 110, and will serve as “Account Administrator” of the new gateway 118. This custom gateway 118 may be set up for the organization 110, or it may be even set up specifically for the event 116 of organization 110.

In the case of pre-existing gateway 114, the service provider 116 simply obtains access privileges from the organization 112 which operates the gateway.

In use, the flow of financial settlement information from the gateway to the various banks and issuers may be different than depicted. In general however, the credit card settlement network 120 will be used to authorize a payment from the bidder's bank 122 (if this is different from the issuing bank) and will be used to deposit funds into the bank of the charity 124. Charity bank 124 may not be the only bank receiving funds from a given transaction or group of transactions obviously, there may be fees to various organizations, additional banks for additional charities or from additional bidders and so on and so forth.

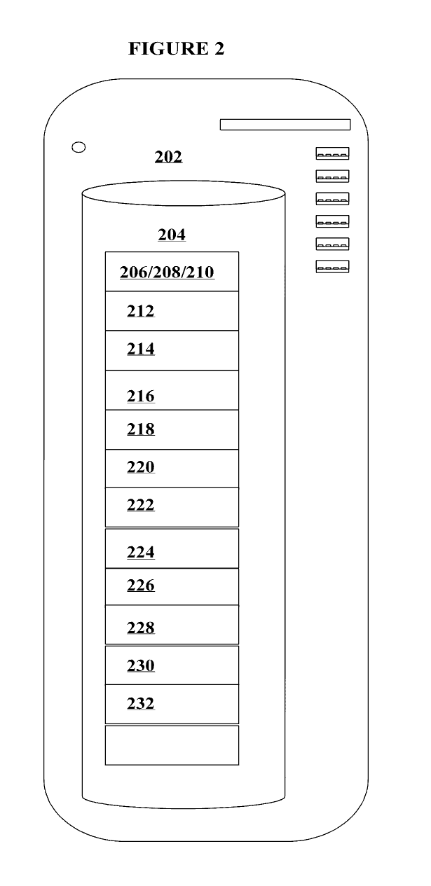

FIG. 2 is a block diagram showing important modules of the system, certain hardware components, etc. Security compliant server 202 may be on-site if this is possible within industry security standards, but a remote location may be preferable in embodiments. In addition to a server CPU, it will have non-volatile memory 204 containing machine readable programming instructions and machine accessible databases of information. The server 202 may act in accordance with the instructions and data outlined below.

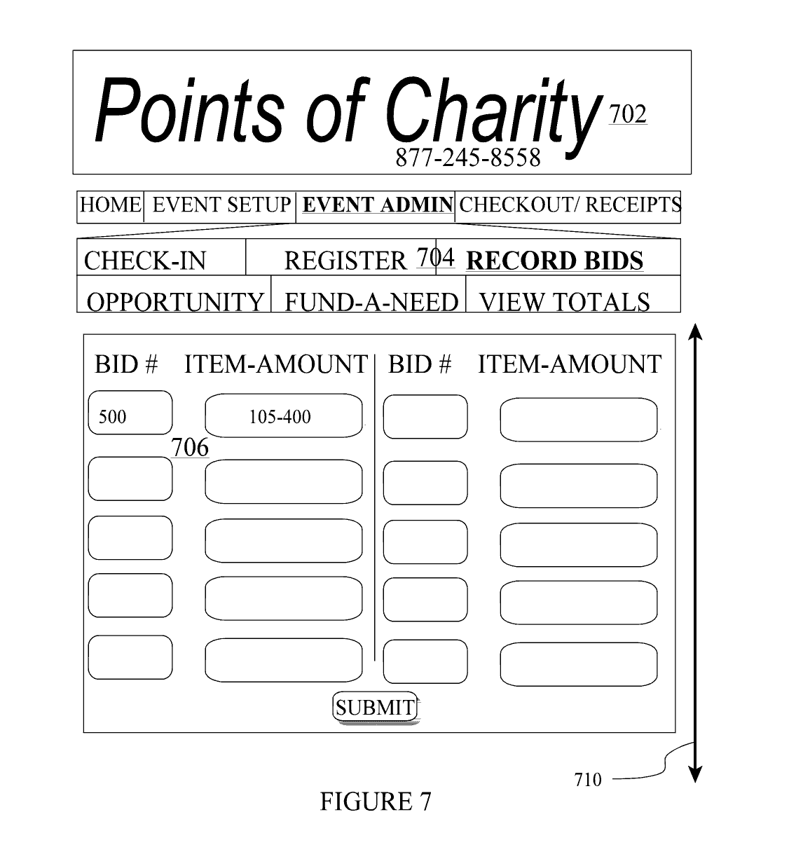

Note that many of these modules are given further explanation in regard to FIGS. 7 through 15, however, FIG. 2 shows an over-view block diagram of the server functions/modules.

Bidder Profile database 206 contains more than just data about the bidder. As noted previously in addition to routine name, address, past bidding history, charitable notes, etc, it will contain bidder location information and a dynamic table assignment per module 208. This information will be updated for each event the individual/entity attends with the goal of having a physical location (such as a table number or seat number) available for each bidder, thus allowing further contacts later in the auction process, as will be discussed below. Bidder payment information 210 may also be found in the Profile in embodiments, however, industry security regulations may now or at a later time require this information be protected in a separate database, for example, a different server or the like, in which case the bidder payment information 210 will be a database of access information (codes, PINs, etc) allowing computer access to the same information in any case.

Test transaction module 212 is important in that it allows verification of the payment information bidders will provide at registration. For example, some card companies issue cards which have a pattern which makes it literally hard to read embossed or printed non-magnetic information such as CCV codes or expiration dates. By submitting a test transaction at a convenient time (such as immediately, or during the auction process) the auction staff can be assured that all information is correct. The test transaction may be voided immediately. In embodiments, the test transaction may be an opportunity or sale or donation, for example a “$5 table reservation fee” or a meal fee or the like.

Donation module 214 allows patrons/bidders to make donations, allowing them further to choose, if multiple causes are available, and thus to “Fund-A-Need” which they feel attracted to. Sales module 216 serves essentially the same function, for example allowing the purchase of wine or the like.

Date input module 218 in fact may serve multiple functions or may be replicated in numerous ways: as discussed below in reference to later figures, this module/these modules may serve to allow manual input or over-ride of patron Profiles, seat assignments, item uploading prior to the auction, Patron sticker printouts, bid sheet printouts and much more. These modules will normally be customized for each particular purpose, again serving the over-riding goal of providing a seamless, speedy process for staff to serve patrons.

Batch payment submission 220 is a module of great centrality to the invention. This module leverages the power of certain gateways to allow batch processing of groups of payments during or after the auction event. This advantage in turn is leveraged to allow a wide range of responses to patron/bidder issues with payments, to allow easier announcements of winners and losers and more. In general, a staffer using the device of the invention/method of the invention may, if the situation calls for it, indicate a group of bidders, or indicate ALL winning bidders and others owing money to the auction, with a single mouse click/keystroke/command/menu command/soft button. The same staffer can then with a second command/mouse click/keystroke/button press/menu command submit all outstanding receivables (payments) via the payment gateway, all at once. Due to the speed of the credit card settlement network system 120, confirmations of the payments being successfully processed (or not) will being to arrive back to the auction staffer almost immediately.

Receipt module 222 will allow patrons to see how much they have spent or donated, the SRV (standard retail value) of items for tax purposes, local sales tax rates, if their payment was successful and so on and so forth.

SMS text module 224 will be discussed at great length below. In essence, a bank or database of templates allows the auction administrators to send semi-personalize/semi-custom messages to bidders to let them know information such as which silent auctions they won or lost, their total payment due and more. Importantly, it will allow the administrators to discreetly inform a distant patron that a payment has failed.

Spreadsheet module 226 allows downloading of empty spreadsheets from a service provider to a client/sponsor organization to allow the sponsor to easily, in a standardized way, provide information about patrons or items for auction and so on. The power of this module is that the same spreadsheets, loaded with data, may then be uploaded back to the service provider and using the device and system of the invention, used to populate the auction, the list of expected attendees and so on.

Check-in module 228 allows check-in of the attendees. In the best mode now contemplated, this may be a double module for “check-in” versus “registration”. Registration may be the time at which credit card information is collected, as discussed below.

Item counter module 230 allows real time access to the items which have sold and which have not, or updates, reports, input and so on. In prior methods, advanced report generation may not be available, whereas in the present invention it is possible to use this module, and the next, for real-time or near real-time reports to the administrative staff or the host organization.

Revenue module 232 tracks revenues as they come in, thus allowing organizers to know where they stand as the event is progressing. While after-the-fact reporting is known, instantly available reporting on amounts bid and receivable, amounts processed and received and more can give organizations the flexibility to launch additional appeals (“We're almost at our goal tonight!”) or mention popular items (“Has everyone had a chance to bid on the Costa del Sol, Spain? That seems to be popular here tonight!”) for further bidding encouragement.

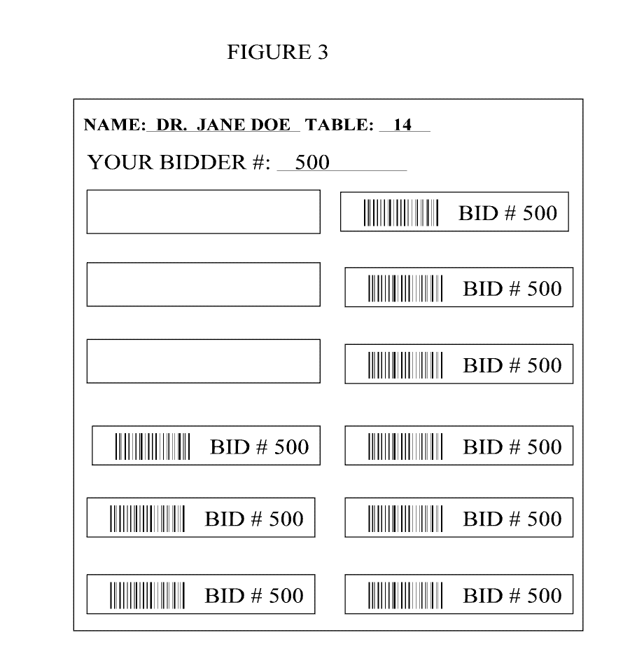

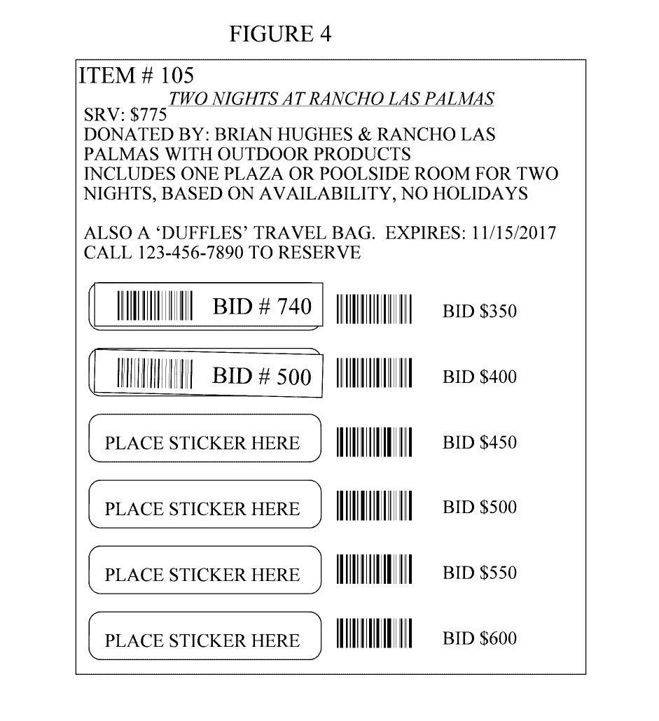

FIG. 3 is an exemplary sticker sheet according to the bid sticker sheet of the invention. (This may also be called a “sticker sheet” or a “bidder sheet” or similar variations, but it is entirely different than a “bid sheet” of FIG. 4.) It may be seen that the bidder has a number of stickers which have a machine readable bar code thereon. In the preferred embodiment, the machine readable code will be supplemented with a notation such as “Bidder #500” which is human readable, or the same lettering may be both machine and human readable. During a silent auction the bidder will pass among the displayed auction items and when something is appealing, may as an impulse purchase bid upon it simply by removing one of the stickers and placing it in a bid location on the bid sheets, which will be shown next.

It may be seen that this bidder has already bid several times.

In addition to bidding, the stickers may be used for other purposes: bidders may mark or purchase or donate using the stickers. In addition, the stickers might be used to aid event administration in ways other than bidding.

FIG. 4 is an exemplary bid sheet according to the invention. The product (a vacation package or weekend getaway, with a travel bag thrown in as a sweetener) is discussed. (In a real display, there will be graphics, pictures, more enticing verbiage and so on, which may be associated with the bid sheet, on the bid sheet, etc. The bid sheet is simplified for clarity.) It may be seen that the exemplary bidder (#500) from FIG. 3 has already affixed a sticker, the second bidder to do so after bidder #740 even though bidding has barely begun.

One advantage of barcode scanning is that the angle of the scan can be quite wide. Bidder #500 has placed her sticker at a slight angle, but the scanner gun or flatbed scanner used at the administration post will have no trouble with this.

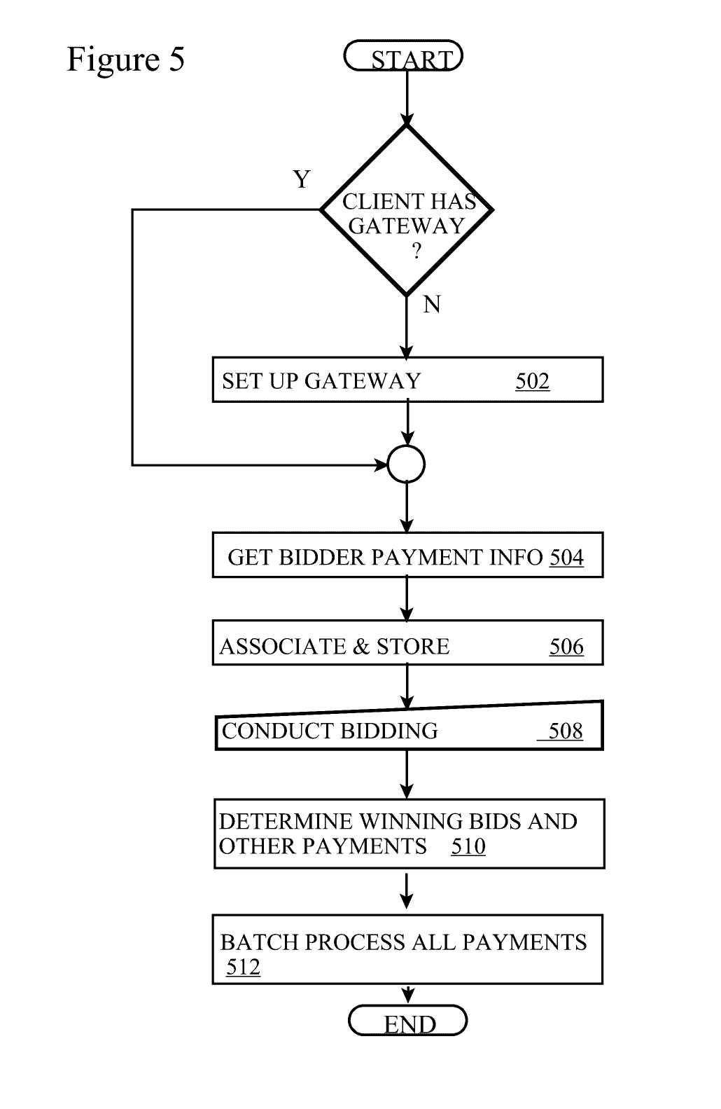

FIG. 5 is a flow chart of the steps of the invention.

Set up custom gateway step 502, as discussed, allows a service provider to create a custom gateway for a client organization, or even for a specific event. This gateway, properly set up, will allow batch processing of payments, which in turn allows for further processes (the revenue tracking module, SMS text messages to bidders with payment issues, etc) which would be otherwise unavailable.

Obtaining bidder payment info & creating a Patron Profile 504 is the creation, if necessary, of the database(s) 206, 208, 210 as discussed previously. This may occur at a check-in table, a registration table, by phone, electronic means, or otherwise. In one embodiment, check-in may be separated from registration so as to have two lines moving at the appropriate speed. Ideally, the goal is to not have patrons of charity standing in line at all, as with minimal scanning and one or two questions they can be processed in, payment information gathered, their paddles and sticker sheets printed and their table location shown to them, all in moments using the invention.

Associate and store Profile, compliant with security regulations, step 506 is the center of the method and system of the invention as the Profiles may now contain all of the information auction staff will need for smooth, seamless, speedy interactions with the patron.

Bidding, step 508, may as noted be of several different types and carried out verbally, thus providing the entertainment value and financial value of the traditional auction format, as well as silently with stickers removed from sticker sheets and affixed to bid sheets, opportunities, need funding and selection, sales, meals, drinks, and more. The method of the present invention allows for and speeds many customary formats of auctions.

Determine payments 510 is the step at which scanning speed and the ability of the present invention to determine a winning bidder, winning bid and item, but with two scans instead of three, comes into play. A flat bed or hand held scanner, or sheet fed scanner, or even a smart phone with the proper app, may be used to obtain the highest item-price combination bar code which has a bidder's sticker affixed thereby. After two scans, the matter has been handled and is ready for processing. Additional scans may be optionally used, for example for extra informational purposes as discussed below, or for determination of a second winning bid if the first winning bid falls through due to absence of the winner or the like. However, at core the present invention's use of a unique bar code, combining both an item identification and a bid amount identification into a single code, allows ⅓ of scanning to be eliminated compared to prior art systems, and this savings is prior to the additional time savings offered by other steps of the invention.

Batch process payments 512 is a step believed to be unique in auction technology to the present invention only. By use of the capabilities of a properly set up gateway, two click batch processing, and the speed of the credit settlement system 120, the auction staff and administration are instantly made aware of any issues and can resolve them as the auction is proceeding, that is, while the bidders are physically present for contact.

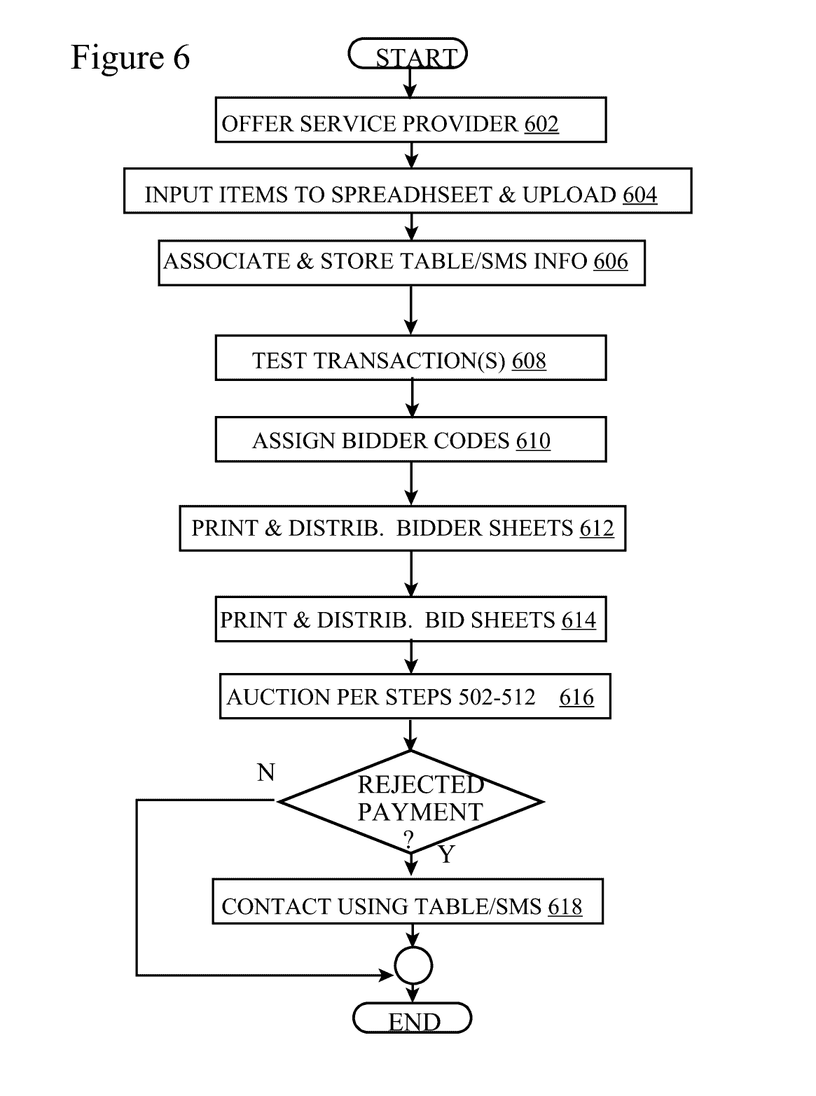

FIG. 6 is a flow chart of the steps of the invention according to an alternative embodiment.

Offer service (provider) 602 is the part of the invention relating to the auction service provider: the present invention allows quick application of the auction information to the pre-made system of the invention and thus provides the benefits of the invention to a much broader group of organizations than otherwise, especially organizations which lack the ability to hold such a seamless auction.

Input items 604 is the spreadsheet or manual step of setting up the auction items, again, this step is greatly eased by the processes of the invention.

Associate & store contact information of bidders 606 is the creation, or downloading, or uploading, of bidder information to create the Patron Profiles.

Test transactions 608, also as discussed previously, allows the creation of a test transaction to validate payment information and thus straighten out, prior to the bidding step, any issues.

Assign bidder codes 610 and print & distribute bid sticker sheets 612 is the registration process step, or a later step, at which bidders receive their sticker sheets with an assigned number thereon.

Note that these early steps in the process correspond to an overall “check-in”/“registration” phase and thus may occur at approximately the same time. As one example of one possible embodiment of the invention, if a patron is providing their payment information at the door of the event, steps 606, 608, 610, 612, and 614 (among other options) are likely to occur close together and very quickly.

Note that print & distribute bid sheets 614 is a step which can happen well before the event if the items have been entirely processed before the event. Thus this step may occur at a number of different times.

Thereafter, auction steps 502-512 are carried out (this grouped into step 616) as discussed previously.

After the first batch processing, it is likely that some payments will have failed for one reason or another as already discussed. Since the processing is so quick, it is then possible to, on-site, by SMS or face-to-face, contact patrons associated with rejected payments (step 618).

FIG. 7 is a greatly simplified screenshot of a module which records bids, provides information on bidding and so on.

One major area of speed advantage of the present system is shown here. The page is laid out in a standardized format with various speed/ease of access features built in.

Page header 702 and tab system 704 are standardized to as many pages of the system of the invention as is possible. The content of the header is optional, obviously. The tabs however, are faster for providing access to a wide variety of system functions, reports, data entries and more. Since speed is of the essence at a live auction, a tab system rather than other systems is a definite advantage.

Below the tab system, each page will have an area for data input or for the display of tabular information (706). This particular page is used for bid recordation, a similar page then provides tabular display of all bid information as yet entered, other pages use the same overall format for totally different functions and so on.

Vertical height limit 710 is another subtle feature of the invention which aids speed of service.

In use, scrolling up and down is found to be an enormous waste of staff time, one which is tolerated because the wasted time is stolen only a few seconds at a time. However, by establishing a vertical height limit for pages, this limit based upon either typical monitor size, an automated determination of monitor height, or simply on the display size of the devices used by the service provider or host organization (mobile devices, small computer screens, larger screens and so on), scrolling may be minimized. Longer tabular displays will of course require a scroll bar, but most functions of the invention can be accessed and used without any scrolling.

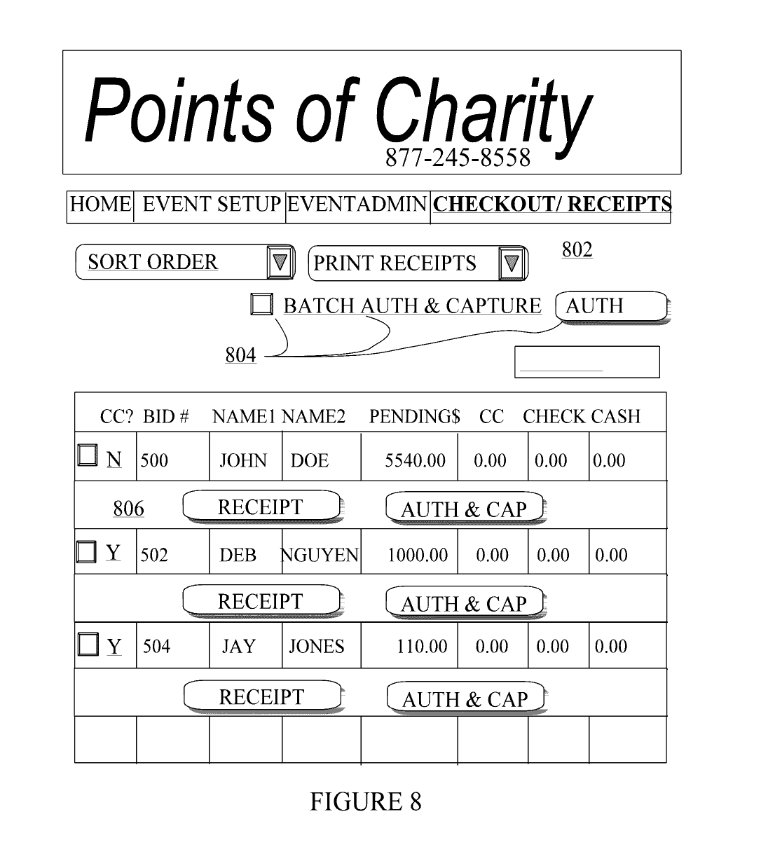

FIG. 8 is a greatly simplified screen shot depicting a module which allows two-click batch processing of all orders, whereby the invention allows much greater speed as well as additional structures which could not be provided without leveraging this ability.

Receipt printing 802 is a necessary function as patrons will require tax information (SRV, etc) and the organization will wish to have printed proof of auction outcomes. Since guest Profiles may provide location of the patron at the event, it is once again possible to deliver receipts to tables without forcing patrons to stand in lines at the end of the event.

Batch processing (esp. payments) 804 has already been discussed, but it may be seen that two click boxes are all that is required for processing, or for that matter for receipt printing. A “batch capture and authorize” box will select every outstanding amount with a single click, while the soft button to authorize the charges takes only a second click. This takes advantage of the power of the customized payment gateway.

For contrast, in the prior art systems, after a triple scan it is necessary to process payments by whatever means are available—possibly one payment at a time—and this process may stretch out much longer than the event, which in turn means that bidders are not available to answer questions about charges, receipts must be delivered later, the auction does not flow as smoothly and so on.

Data display area/tables 806 shows that each page may have different tables for different purposes: in this case, showing which bidders owe how much.

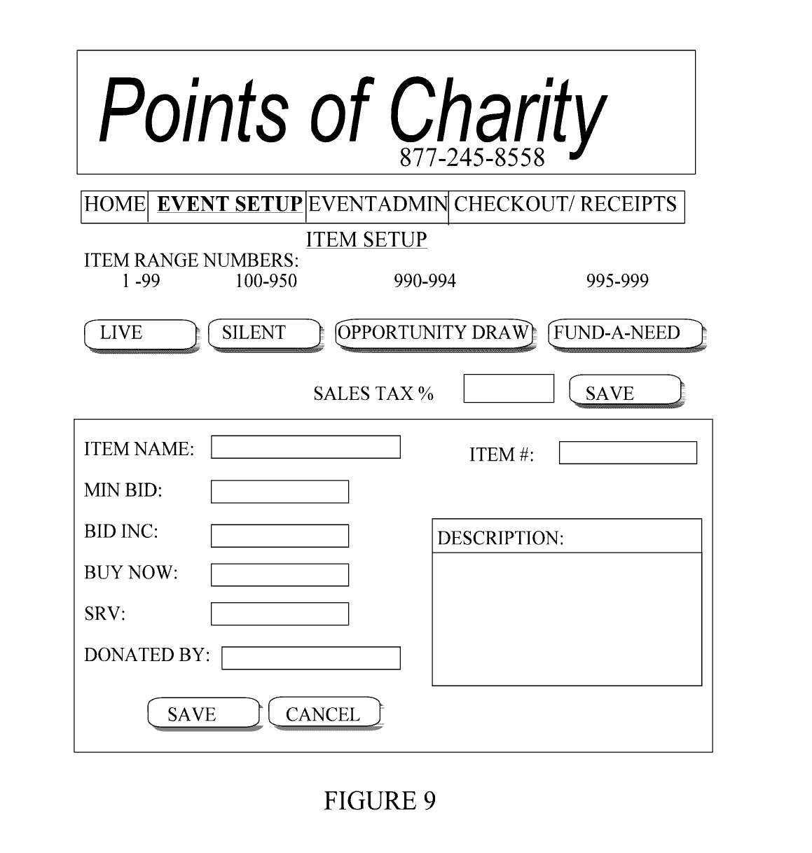

FIG. 9 is a simplified screenshot of an item setup/data input module of the invention allowing auction staff to create an auction with great speed. This manual option allows the creation and printing of a bid sheet or other material for any type of opportunity, fund-a-need or the like. Entering data manually is slower but often necessary compared to the process shown in the next figure.

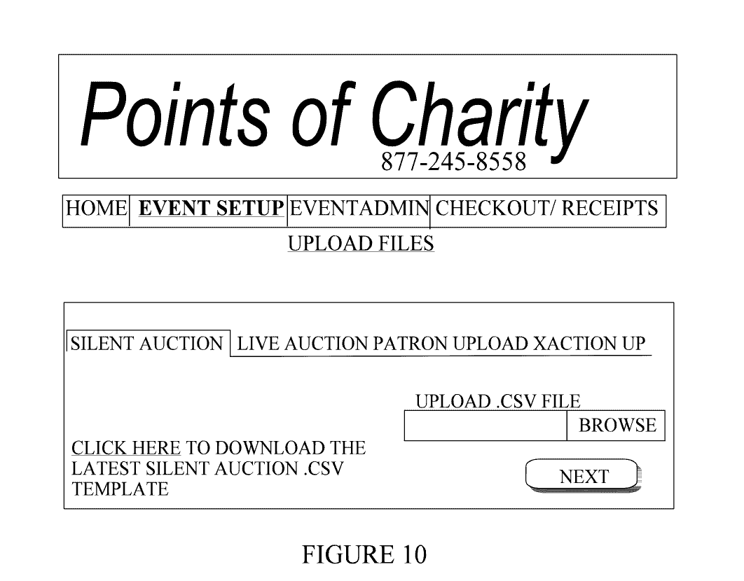

FIG. 10 on the other hand is a simplified screen shot of an event set up screen allowing automatic creation of a silent auction (items in particular) from a spreadsheet, thus allowing a host/sponsor organization to easily interface with an auction event providing organization. It may be seen that a spreadsheet in a common format such as .csv or .xls or the like is available for download. If the user has a spreadsheet already populated with items, it may instead be uploaded. Thereafter, the items of the auction are populated automatically and ready for printing of bid sheets or the like.

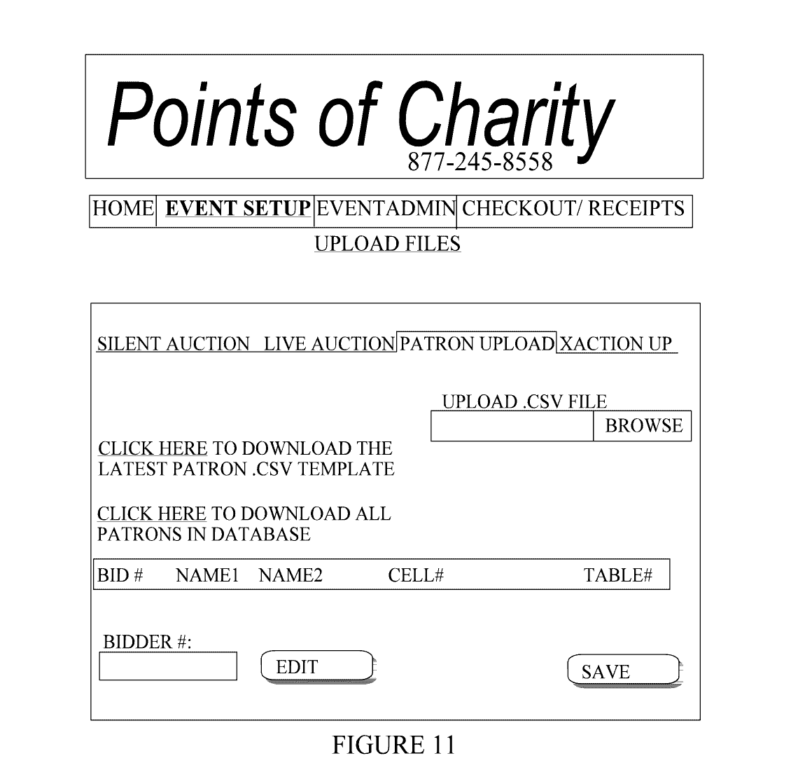

FIG. 11 is a simplified screen shot of an event set up screen allowing automatic entry of patrons/bidders of the auction, and showing that bidders may in fact be saved from event to event in the files of the auction event provider. Notice that this too is partially automated: a blank spreadsheet may be downloaded or a populated spreadsheet may be uploaded to populate the Profiles database for the event. Ideally, if a hosting organization is well prepared, it can provide this information and a bit more and the service provider can create auction materials in mere minutes.

An additional feature is that the host or service organization may already have a list/database of patron profiles. If so, this module allows downloading of that list, in which case the creation of the even the Profiles database for the event is as simple as finding out who RSVPs or who actually checks in or registration.

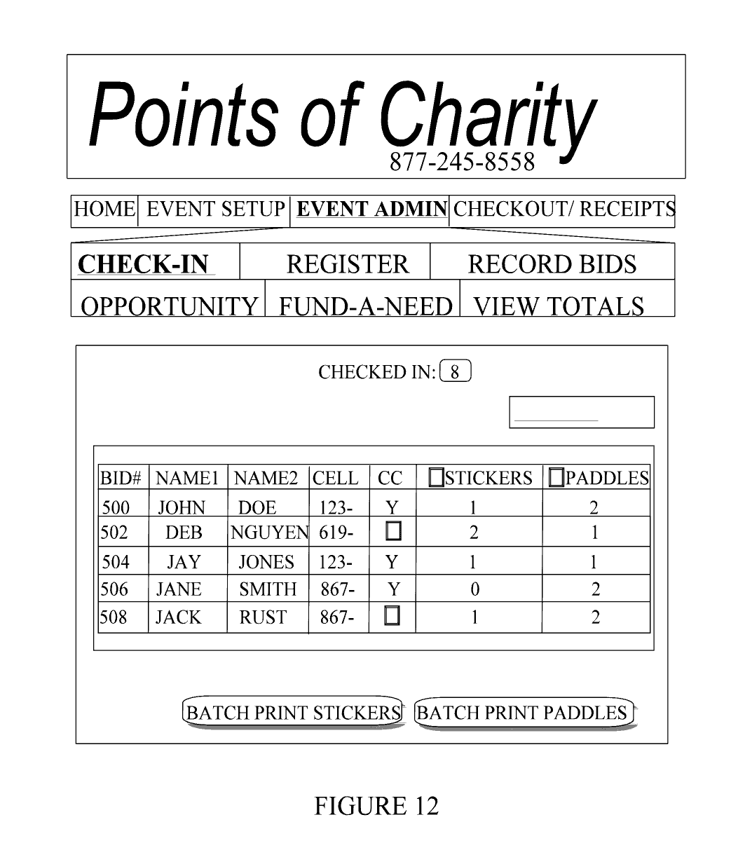

Checking in is found FIG. 12 is a simplified screen shot of a check-in module, showing the invention's ease of checking attendance, printing out stickers for a silent auction, paddles for a live auction and so on. Notice that 8 people (in five groups) have checked in so far. Two of these individuals have not yet gotten their payment information associated with/into their Profile, or they may simply wish to pay by check or cash. One individual, bidder #506, has no wish to participate in the silent auction but has two paddles for the live auction. More information is available through this module but these examples suffice.

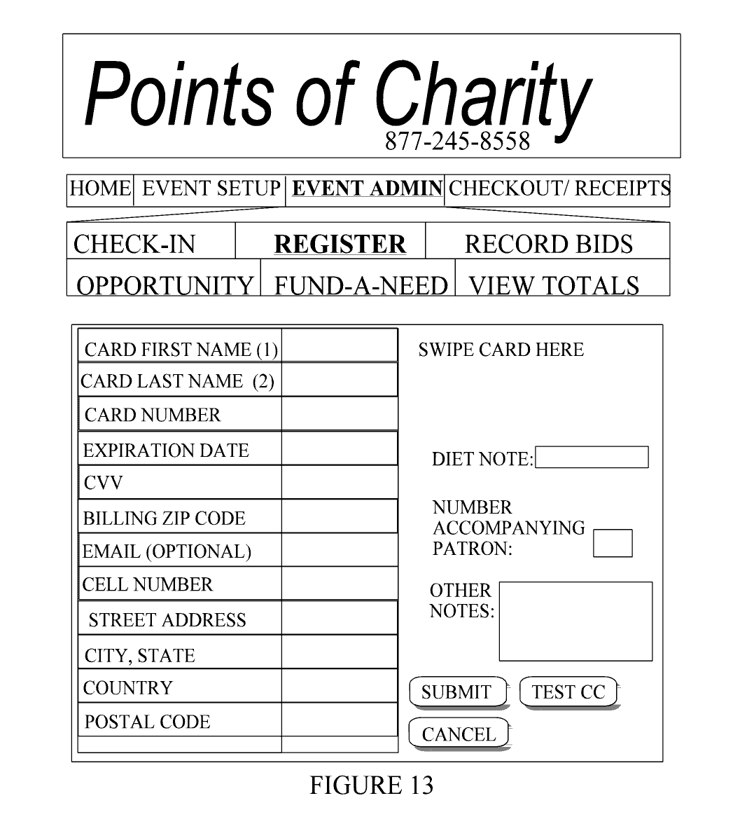

FIG. 13 is a simplified screen shot of a data input module for bidder registration, focusing in particular on entry of payment information for later use. This layout is vastly compressed and simplified for clarity, as discussed previously all screenshots are. An option to enter the required information and submit it to the database of patrons, or to test the information provided, are the main intended outcomes. Other options allow special notes such as diet (“Vegan”, “Kosher”, “Halal”, etc), people accompanying the patron, other notes (“Table near door”) and so on.

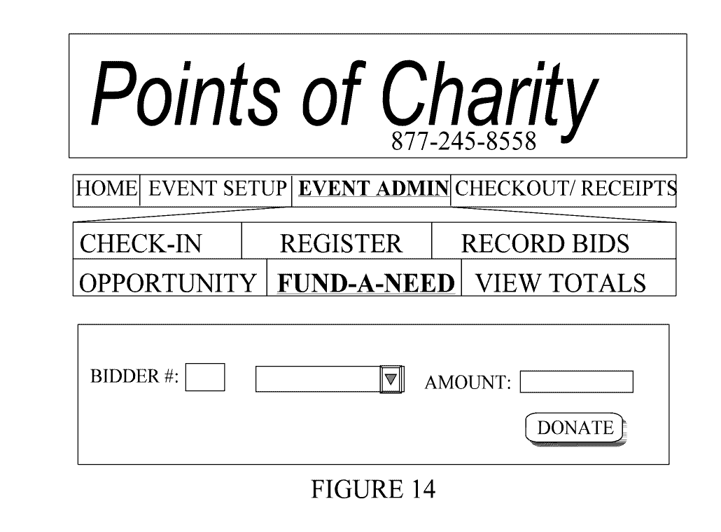

FIG. 14 is a screen shot of a module showing that patrons may be more than bidders: they may also make donations by funding a specific need which they can select. Thus a bidder might hear of a cause or need they wish to support and by means of this function, the staff can collect bidder number, select the desired need to fund, and enter an amount to donate. This “Fund-A-Need” option is handled simply and quickly by the device of the invention.

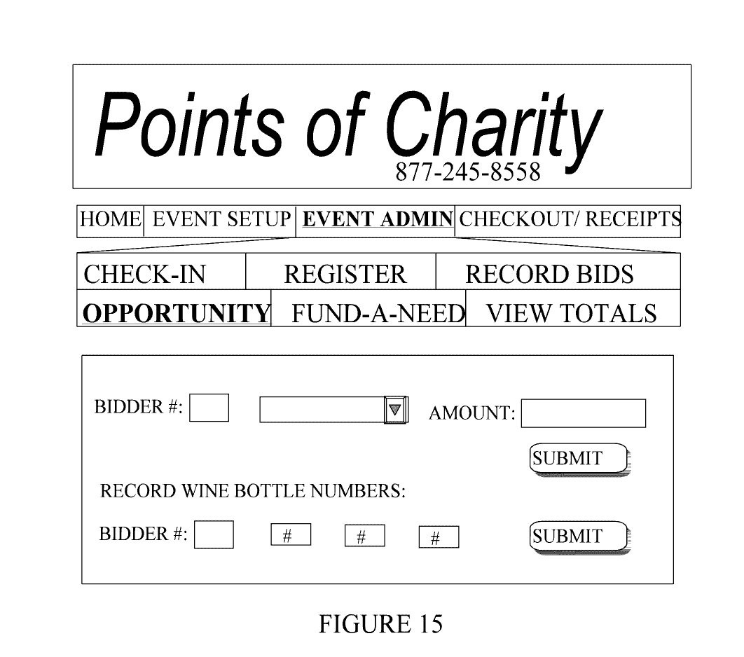

FIG. 15 is a screen shot of an almost equally straightforward “Opportunity” module of the invention allowing patrons to purchase items for sale at the auction. Once again, bidder number, selection of item and if necessary, amount, may all be entered with about three entries.

Another feature of this invention is an integrated SMS text messaging interface that provides the event administrator with SMS text messaging capability.

At the option of the client, patrons who have checked into the event and provided their cell phone number can receive a SMS text message containing a link to a personal event webpage. Each link is unique for each patron as their personal event page may contain the respective patron's editable contact information and dynamic receipt as well as other pages or information that may include but not be limited to Terms & Conditions, Privacy Policy, FAQ's, or an About Us page. Any edits made to the patron's contact information from this interface is automatically updated in an electronic database.

At the conclusion of the silent auction, a SMS text message can be sent to all silent auction participants who won a silent auction item.

At the conclusion of the silent auction, a SMS text message can be sent to all event attendees who did not win a silent auction item.

SMS text messages can be sent to individual patrons, small groups of patrons or all patrons.

The SMS text messaging feature uses short codes so that SMS text messages may be personalized such as, but not limited to the following: [f]=First Name, [l]=Last Name, [b]=Bidder Number, [i]=Item Name, [n]=Item Number, [u]=Unique Patron URL, [t]=Table Number.

The SMS text message feature allows the event administrator to save multiple pre-written SMS text messages.

This feature allows even easier contact with bidders, as the SMS text messages may be customized and yet also batch processed.

Alternatively, though it would be less efficient as it would require additional scanning of machine readable codes to record sale information to a database, the present invention nonetheless contemplates that some auction sponsor's may desire to scan the machine readable item code separately from the price code. Each machine readable item code may include additional information including, but not limited to an item expiration date, quantity, color, whether the item is paired with any other merchandise, the minimum bid price, the bid increment and the maximum purchase price. A unique data string identifier or a data string separator or a series of data string identifiers or separators, if any, may be inserted with the item code information to allow computer code to sort each data string in the item code information to the desired fields in a database.

It is another feature of the present invention that the machine readable codes allocated to the auction participants, auction items or bid prices may also contain empirical data in addition to the respective assigned code. Empirical data includes, but is not limited to a bidder code, an item code, a price code, an item-price code, the event ID, purchase auction terms & conditions, the auction date, the auction location, the auction auction sponsor's name, information specific to the respective bidder, information specific to the person or company that donated the auction item, additional item information not printed in human readable form on the bid sheet, the event type such as a gala, a golf tournament, a convention, an awards ceremony or any other type of event that may host an auction, an auction item expiration date, item quantity, item color, whether the item is paired with any other merchandise, the item's suggested retail value, a minimum bid price, a bid increment, a maximum purchase price, an incentive associated to the specified price or a method of determining the number of competitive bids that may have preceded the winning bid by knowing the position of the winning bid in the bid price hierarchy.

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

I, David Pesch, claim:

1. A method of conducting on behalf of a client organization an auction of a plurality of items and also with a number of bidders, each bidder having at least one electronic payment method, the method comprising the steps of:
prior to the auction setting up a payment processing gateway account operable to capture and store payment information for such electronic payment methods and further operable to process payments made using the payment information;
prior to the auction obtaining from each such bidder, such bidder's payment information for such bidder's electronic payment method, associating such bidder's payment information with such bidder, and storing the payment information in a first database accessible to the payment processing gateway account;
allowing bidding by such bidders on such items;
after bidding has ended, determining a winning bid for each item and associating such winning bid with a winning bidder selected from among such bidders;
after determining winning bids, batch processing payments of the winning bidder of all such items using the stored payment information for such electronic payment methods associated with each winning bidder.

2. The method of conducting an auction of claim 1, further comprising:
providing a service provider organization able to service multiple such client organizations, the service provider organization having the ability to set up at least one unique payment processing gateway on behalf of each such client organization.

3. The method of conducting an auction of claim 1, further comprising:
providing a service provider organization able to service multiple such client organizations, the service provider organization having the ability to access at least one unique payment processing gateway belonging to such client organization.

4. The method of conducting an auction of claim 2, wherein such client organizations may be one member selected from the group consisting of: charity organizations, professional auctioneers, auction houses, receivers, governmental organizations, private businesses and combinations thereof.

5. The method of conducting an auction of claim 2, further comprising:
prior to the auction associating with each such bidder at least one piece of contact/location information of each such bidder, the contact/location information selected from the group consisting of: mobile telephone number, mobile device contact information, email address, other electronic address, seat number, table number, room number, and combinations thereof.

6. The method of conducting an auction of claim 5, further comprising:
after batch processing of payments, using such bidder's contact/location information to contact such bidder in any event selected from the list consisting of: the payment being rejected, such payment information being rejected, the payment being accepted, and combinations thereof.

7. The method of conducting an auction of claim 6, further comprising the steps of:
providing an industry compliant gateway server having a process and having a non-volatile memory and having in such non-volatile memory instructions for carrying out at least one of the steps of the invention;
performing using the industry compliant gateway server the one step of the invention per the instructions.

8. The method of conducting an auction of claim 6, wherein the step of setting up at least one unique payment processing gateway on behalf of each such client organization further comprises:
setting up at least one unique payment processing gateway for each individual auction of such client organization.

9. The method of conducting an auction of claim 6, wherein the electronic payment method is a credit/debit card, and further wherein the payment information is one member selected from the group consisting of: card number, card holder name, CVV code, card holder address, PIN number, and combinations thereof.

10. The method of conducting an auction of claim 9, further comprising the step of:
initiating a test transaction using the stored payment information, and
if the test transaction fails, using such bidder's contact/location information to contact such bidder.

11. The method of conducting an auction of claim 10, further comprising the step of:
if the test transaction occurs, voiding the test transaction.

12. The method of conducting an auction of claim 9, further comprising the step of:
offering to such bidders the option to make a donation to such client organization,
if one such bidder makes a donation, using the stored payment information to process the donation.

13. The method of conducting an auction of claim 9, further comprising the steps of:
prior to the auction assigning to each such bidder a unique bidder code, which bidder code is machine readable, and storing such unique bidder code associated with such bidder payment information;
providing to each such bidder a bid sticker sheet having thereon at least one sticker printed with such bidder's unique bidder code, the at least one sticker having a size and shape;
prior to the auction creating a bid sheet having thereon a plurality of item-price codes, each item-price code being readable both by machine and by such bidders, each item-price code identifying one such item being bid upon and a price bid for that item, the plurality of item-price codes on the bid sheet each being for the same item but for different prices for such item, the prices spanning a desired range of bidding;
the bid sheet having associated with every item-price code at least one bid space matching the stickers' size and shape;
during bidding allowing such bidders to remove from their bid sticker sheet the at least one sticker having thereon such bidder's unique code, and allowing such bidder to place the at least one sticker upon the bid sheet in the bid space;
whereby the bidder silently and potentially anonymously bids upon such item;
at the conclusion of bidding, gathering such bid sheets and scanning in the unique bidder code found upon the sticker in the bid space associated with the highest item-price which was bid for such item, whereby a winning bid and a winning bidder for each such item is determined;
processing payment information associated with such bidder, for the amount of the item-price bid.

14. The method of conducting an auction of claim 13, wherein:
if one such bidder has become the winning bidder for more than one such item, totaling the amount of such bidder's winning bids prior to processing that bidder's payment information;
whereby in the event that such bidder's payment fails, the bidder may be contacted for potential partial payment.

15. The method of conducting an auction of claim 14, further comprising the steps of:
at the conclusion of bidding, gathering such bid sheets and scanning in the unique bidder code found upon the sticker in the bid space associated with the second highest item-price which was bid for such item, whereby a substitute winning bid and a substitute winning bidder for each such item is determined;
in the event that processing the winning bidder's payment information fails, processing payment information associated with such substitute bidder, for the amount of the substitute item-price bid.

16. The method of conducting an auction of claim 13, for use with a bidder having a second payment method, the method further comprising the steps of:
obtaining from such bidder, such bidder's second payment information for such bidder's second electronic payment method, associating such bidder's second payment information with such bidder, and storing the second payment information in the database accessible to the payment processing gateway account;
prior to processing payments, offering to such bidder the option to divide payment among payment methods selected from the group consisting of: such second payment information, such first payment information, a cash payment, a check payment, and combinations thereof.

17. The method of conducting an auction of claim 13, wherein the step of batch processing payments further comprises the steps of:
activating with a first command a selection module which selects all of the winning bidders at once;
activating with a second command a submission module which submits all payments at once via the payment processing gateway account.

18. The method of conducting an auction of claim 17, wherein the step of batch processing payments further comprises:
the submission module activating a receipt module operative to create a receipt for each payment which is successfully processed,
the submission module leaving payments which failed to process showing in a payments receivable module.

19. The method of conducting an auction of claim 18, further comprising:
the submission module generating a report showing a status for each payment, the status for each payment including an indication that the payment was successful or in the alternative indicating that the payment failed and a reason for failure.

20. The method of conducting an auction of claim 19, further comprising:
an SMS text messaging module operative to generate and send to each such bidder, after bidding has ended, an SMS text message informing the bidder of all auctions they won, all auctions they lost, and related information;
the SMS text messaging module having a second database of template SMS text messages which have fields which may be auto populated by the SMS text messaging module, the fields including at least one member selected from the list consisting of: first name, last name, bidder number, item name, item number, table number, payment amount, winning bid amounts, and combinations thereof.

21. The method of conducting an auction of claim 19, further comprising:
providing a spreadsheet module allowing easy data entry into a spreadsheet of a list of silent auction items, live auction items, such bidder information, such bidder payment information, and combinations thereof;
providing an input module operative to receive the spreadsheet and save the contents of the spreadsheet, thereby populating the first database automatically;
the input module further operative to receive the spreadsheet and generate the bid sheets and the bid sticker sheets.

22. The method of conducting an auction of claim 19, further comprising:
providing a dynamic table assignment module allowing the batch uploading of table assignments, individual table assignments, and table reassignments.

23. The method of conducting an auction of claim 19, further comprising:
providing a check-in module displaying the number and identities of such bidders who have provided such payment information by checking-in.

24. The method of conducting an auction of claim 19, further comprising:
providing an item counter module operative to track the number of such items, the item counter module further operative to enforce a limit on the number of such items.

25. The method of conducting an auction of claim 19, further comprising:
a page size limitation, the page size limitation being a maximum limit to the vertical height of a single page display, the page size limitation being set to be no larger than the height of a first electronic display screen, the page size limitation being enforced for all pages displayed while carrying out the invention;
whereby at no time is it necessary to scroll while carrying out the invention.

26. The method of conducting an auction of claim 19, further comprising: a total revenue module operative to track and display revenues generated during the auction, the display of the revenues provided both as a grand total and also broken down by a plurality of sub-categories of the event, including auction amounts by type of auction, donation amounts, sales, by such bidders' names, by a table number, and by at least one other bidder characteristic.

27. The method of conducting an auction of claim 19, further comprising:
a suggested retail value for each such item, the suggested retail value being printed upon a receipt for convenient reference for tax purposes.

28. A method of conducting on behalf of a client organization an auction of a plurality of items and also with a number of bidders, the method comprising the steps of:
prior to the auction assigning to each such bidder a unique bidder code, which bidder code is machine readable, and storing such unique bidder code associated with such bidder;
providing to each such bidder a bid sticker sheet having thereon at least one sticker printed with such bidder's unique bidder code, the at least one sticker having a size and shape;
prior to the auction creating a bid sheet having thereon a plurality of item-price codes, each item-price code being readable both by machine and by such bidders, each item-price code identifying one such item being bid upon and a price bid for that item, the plurality of item-price codes on the bid sheet each being for the same item but for different prices for such item, the prices spanning a desired range of bidding;
the machine readable codes printed in a format selected from the group consisting of: UPC-A, UPC-E, EAN-8, EAN-13, QR codes, Aztec, Data Matrix ECC200, PFD417, Code 39, Code 93, Code 128, ITF, other machine readable codes now known or later devised, and combinations thereof;
the bid sheet having associated with every item-price code at least one bid space matching the stickers' size and shape;
during bidding allowing such bidders to remove from their bid sticker sheet the at least one sticker having thereon such bidder's unique code, and allowing such bidder to place the at least one sticker upon the bid sheet in the bid space;
whereby the bidder silently and potentially anonymously bids upon such item;
at the conclusion of bidding, gathering such bid sheets and scanning in the unique bidder code found upon the sticker in the bid space associated with the highest item-price which was bid for such item, whereby a winning bid and a winning bidder for each such item is determined.
